(19) United States
(12) Patent Application Publication
(10) Pub. No.: US 2004/0016242 A1
(43) Pub. Date: Jan. 29, 2004

(54) System for remote control of internet refrigerator and method of remote control thereof

(75) Inventors: Dong-June Song, Busan-City (KR); Gi-Hyoong Lee, Kwanglu City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/422,735

(22) Filed: Apr. 25, 2003

(30) Foreign Application Priority Data
Jul. 27, 2002 (KR) 2002-44483

(51) Int. Cl. G05D 23/00; F25B 49/00

(52) U.S. Cl. 62/132; 236/51

(57) ABSTRACT

A method of remotely controlling an Internet refrigerator having its own proper ID, includes transmitting a variable IP information assigned to the Internet refrigerator where the Internet refrigerator accesses the Internet, and the proper ID, to a server from the Internet refrigerator; storing the proper ID and the IP address information pertaining to the Internet refrigerator in the server; supplying the IP address information of the Internet refrigerator as appropriate, according to the proper ID address inputted by a user who has access to the server through the Internet, to a user terminal; and allowing the user terminal to access the Internet refrigerator, based on the IP information received from the server. Thus, a user in a remote place can access the Internet refrigerator by a remote control through a terminal in the case of the refrigerator assigned a variable IP address.

### CROSS-REFERENCE TO RELATED APPLICATIONS

This application claims the benefit of Korean Application No. 2002-44483, filed Jul. 27, 2002, in the Korean Industrial Property Office, the disclosure of which is incorporated herein by reference.

### BACKGROUND OF THE INVENTION

1. Field of the Invention

The present invention relates to a remote control system of a refrigerator accessible to the Internet and a method of remote control of the refrigerator, and, more particularly, to a remote control system of an Internet accessible refrigerator and a method of remote control of the refrigerator, wherein a user in a remote place can make an access to the Internet refrigerator by a remote control through a terminal in the case of the refrigerator assigned a variable IP (Internet protocol) address.

2. Description of the Related Art

As those technologies for electric home appliances have been developed, an Internet refrigerator, capable of accessing the Internet without a personal computer, has been developed. The Internet refrigerator has inherently been equipped with a function of being accessible to the Internet, and thus, the user can determine a status of the refrigerator, after accessing it through the Internet, or control the refrigerator. Or, the supplier has upgraded software for the Internet refrigerator through the Internet.

To make a direct access to the Internet refrigerator through the Internet outside the home, the user has to know the IP address of the Internet refrigerator accessed to the Internet. Because the user can access to the user's own refrigerator through the IP address assigned to the Internet refrigerator, the IP address assigned to the Internet refrigerator should be fixed. The fixed IP address is comprised of a proper value formed of a limited number of numerals, not overlapping with those of the other users over the world, and thus, the proper value should be assigned by the competent institute, taking the procedure for obtaining the IP. Since it is considerably expensive to obtain a fixed IP, practically most ordinary users having access to the Internet with the use of personal computers have used variable IPs.

As described above, to support a remote access function through the Internet to which the Internet refrigerator is accessed, the Internet refrigerator should be assigned its proper and fixed IP, but, it is currently a burden to the user.

### SUMMARY OF THE INVENTION

Accordingly, it is an aspect of the present invention to provide a remote control system of an Internet accessible refrigerator and a method of remote control of the refrigerator, wherein a user in a remote place can access the Internet refrigerator by a remote control through a terminal in the case of the refrigerator assigned a variable IP address.

Additional aspects and advantages of the present invention will be set forth in part in the description that follows, and, in part, will be obvious from the description, or may be learned by practicing the present invention.

The foregoing and/or other aspects of the present invention may be accomplished by providing a method of remotely controlling an Internet refrigerator having its own proper ID, comprising transmitting a variable internet protocol (IP) address information assigned to the Internet refrigerator where the Internet refrigerator accesses the Internet, and the proper ID, to a server from the Internet refrigerator; storing in the server the proper ID and the IP address information pertaining to the Internet refrigerator; supplying the IP address information of the Internet refrigerator as appropriate, according to the proper ID address inputted by a user who has access to the server through the Internet, to a user terminal; and allowing the user terminal to access the Internet refrigerator, based on the IP information received from the server.

In an embodiment, the proper lb is comprised of a domain name assigned to the Internet refrigerator.

In an embodiment, the server is comprised of a dynamic domain name server (DDNS).

In an embodiment, the step of supplying the IP information to the user terminal comprises determining whether the Internet refrigerator is accessing the Internet; and supplying the IP address information to the user terminal where the Internet refrigerator is accessing the Internet.

In an embodiment, a web page indicating that the access of the Internet refrigerator is released is displayed on the user terminal, where the Internet refrigerator is released from the access.

According to another aspect of the present invention, the above and other objects may be also achieved by providing a system for remotely controlling an Internet refrigerator having an Internet interface for an access to the Internet, a proper ID storing unit storing therein a proper ID of the refrigerator, a web page storing unit storing therein a web page, and a web controlling unit displaying the web page on a user terminal accessed through the Internet, comprising an IP address transmitting unit provided in the Internet refrigerator, transmitting an IP address information variably assigned at time of accessing the Internet through the Internet interface and the proper ID; and a server including a domain storing unit storing therein a proper domain assigned to the Internet refrigerator, a domain controlling module matching the IP address information received from the IP address transmitting unit with the proper domain, and a server controlling unit supplying the user terminal with a current IP address information appropriate for the proper domain of the Internet refrigerator, according to the proper domain inputted using the user terminal.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a schematic diagram of a remote control system of an Internet refrigerator according to the present invention;

FIG. 2 is a control block diagram of the Internet refrigerator of FIG. 1;

FIG. 3 is a flow diagram of a signal for the remote control system of the Internet refrigerator according to the present invention; and

FIG. 4 is a flow chart illustrating a remote access process of the Internet refrigerator according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout.

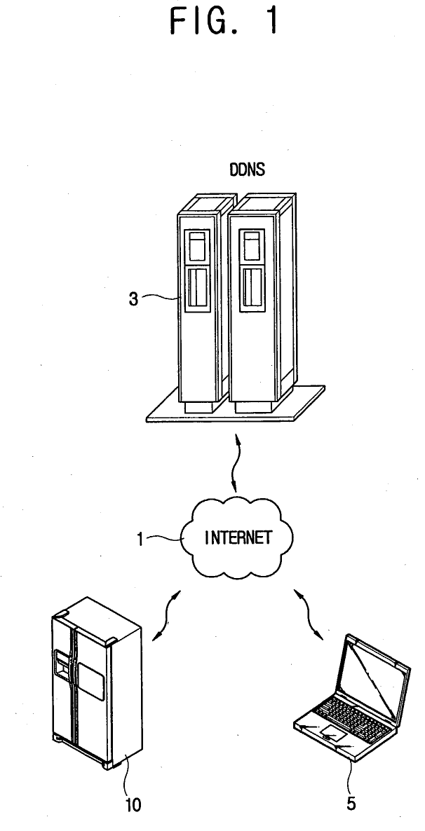

FIG. 1 is a schematic diagram of a remote control system of an Internet refrigerator according to the present invention. As shown in this figure, a remote control system of an Internet refrigerator according to the present invention is comprised of an Internet refrigerator 10 assigned its proper ID with which it can access the Internet 1, a terminal 5 through which a user can access the Internet refrigerator 10 (hereinafter, “a user terminal”), and a DDNS (dynamic domain name server) 3 managing the IP of the Internet refrigerator.

The user terminal 5 is such a terminal that can access the Internet 1, serving the user in a remote place to access the Internet refrigerator 10 through the Internet 1. Examples of the user terminal 5 include a computer, a PDA (personal digital assistant), and a mobile phone with access to the Internet. However, embodiments of the present invention are not limited to such examples, as the user terminal 5 may be any device that accesses the Internet.

The DDNS 3 is a server enabling a variable IP address to be used like a fixed IP address, by performing a function of determining the IP address information matching the domain inputted by the user. The DDNS 3 checks whether the Internet refrigerator 10 has been accessed to the Internet, and provides the user with the IP address information currently assigned to the Internet refrigerator, after determining the variable IP address information variably assigned to the Internet refrigerator 10 to which the user desires to access. That is, the user is allowed to directly access the Internet refrigerator 10 even though the IP accessible to the Internet refrigerator 10 is changed, by providing the user with the IP information matching the proper ID of the Internet refrigerator 10 inputted by the user.

The Internet refrigerator 10 accesses the Internet 1 to thereby provide relevant data to the user terminal 5, and on the other hand, performs a control function as selected by the user through the Internet 1. The Internet refrigerators 10 employing the present system have their own domains allotted to each Internet refrigerator 10 as the proper IDs, and transmit to the DDNS 3 the respective IP address informations variably assigned to the Internet refrigerators 10.

Accordingly, the user ascertains the IP address information of the Internet refrigerator 10 through the DDNS 3, thereby possibly accessing the Internet refrigerator 10 through the Internet.

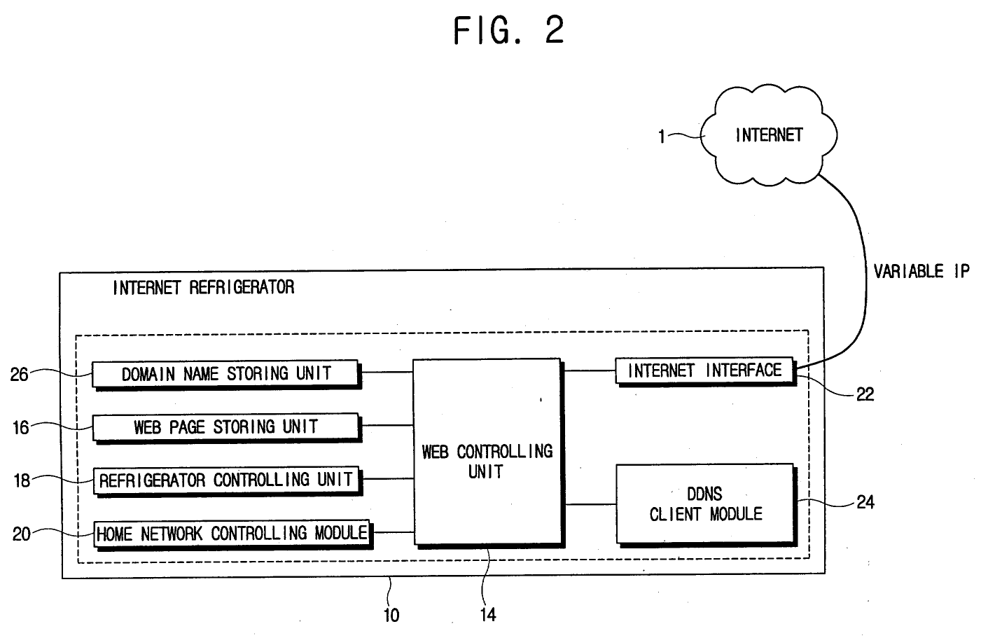

The Internet refrigerator 10 employing the present system may be constructed as depicted in a control block diagram of FIG. 2. The Internet refrigerator 10 employing the present system by a remote control is comprised of an Internet interface 22 enabling an access to the Internet 1, a refrigerator controlling module 18 performing inherent functions of the refrigerator, a domain storing unit 26 storing therein the domain information uniquely assigned to each refrigerator, a World Wide Web (web) page storing unit 16 storing therein web pages, a DDNS client module 24 transferring to the DDNS 3 the IP address information assigned to the Internet refrigerator 10, and a web controlling unit 14 controlling them.

The Internet interface 22 is an Internet connecting unit for connecting an Internet line, for example, xDSL (such as ADSL, HDSL, VDSL, etc.), a cable modem etc., being comprised of a local area network (LAN) card and the like. The Internet interface 22 is possibly accessed to the Internet wirelessly, for example, by employing a wireless LAN card, in addition to the wire access by the units as described above. However, embodiments of the present invention are not limited to a wireless LAN card, as any other component that facilitates wireless Internet access may be used.

The web page storing unit 16 stores therein web pages indicating the data inherently in the user terminal 6 accessed to the Internet refrigerator 10.

The refrigerator controlling module 18 controls general functions provided by a refrigerator, inclusive of, but not limited to, a cooling function thereof. Further, the refrigerator controlling module 18 provides the data concerning a setup status, an operation status of the functions provided through the refrigerator to the web controlling unit 14.

Here, the web controlling unit 14 displays the data stored in the web page storing unit 16 and the information received from the refrigerator controlling module 18 on the user terminal 5 accessed through the Internet 1, so that the user can ascertain the status of the Internet refrigerator 10. The user may change the setup of the refrigerator depending on the status of the Internet refrigerator 10 as confirmed through the user terminal 5, and the web controlling unit 14 supplies the setup information changed by the user as received through the Internet interface 22 to the refrigerator controlling module 18, to thereby reflect the user's selection in controlling the refrigerator.

The Internet refrigerator 10 of the present system further comprises a home network controlling module 20, thereby enabling the electronic devices at home to be controlled by the home network controlling module 20 of the Internet refrigerator 10. The home network controlling module 20 may supply status data of each electric device connected to the network constructed at home to the web controlling unit 14. Here, the web controlling unit 14 displays a status of the home network on the user terminal 4 accessed through the Internet 1, so as to allow the user to change or ascertain the setup of the home network.

The Internet refrigerator 10 of the present system transmits the IP address information currently assigned thereto through the DDNS client module 24 to the DDNS 3. Where the Internet refrigerator 10 is accessing the Internet 1, the DDNS client module 24 ascertains the IP information variably assigned and transmits the current IP information and the domain information to the DDNS 3. This function of the DDNS client module 24 is automatically executed as the Internet refrigerator 10 is accessed to the Internet 1. Where the assigned IP address is changed, it transmits the changed IP address information to the DDNS 3, thereby allowing the DDNS 3 to recognize the IP address for accessing the proper domain of the Internet refrigerator 10 that is accessing thereto.

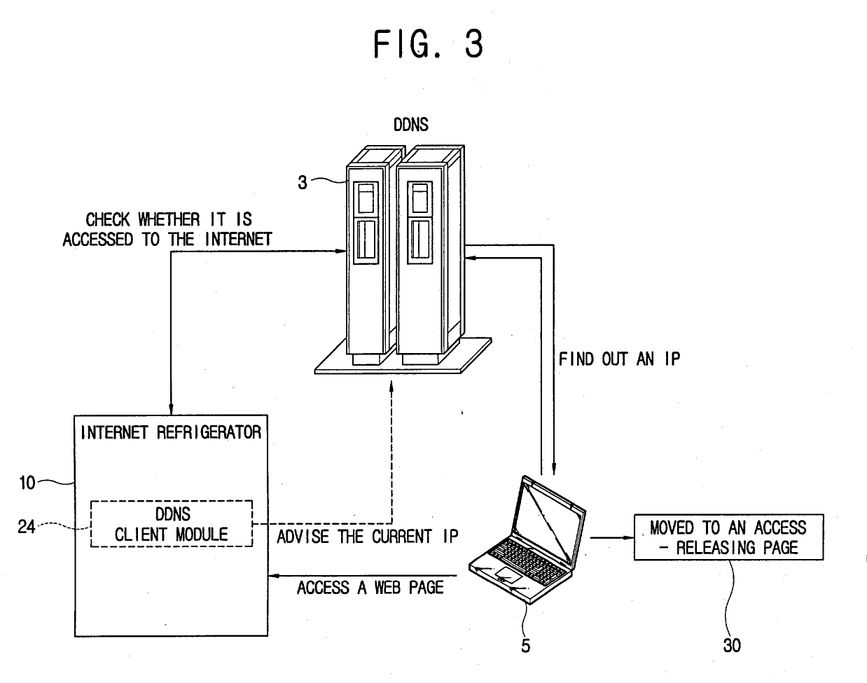

With this configuration, when the remote control system of the Internet refrigerator 10 according to the present invention is practically used, a signal from each constituent element is transmitted as shown in FIG. 3.

As shown in this figure, the DDNS client module 24 of the Internet refrigerator 10 accessed to the Internet 1 transmits to the DDNS 3 the IP address information currently assigned. The DDNS 3 receive the current IP address information received from the DDNS client module 24, to thereby ascertain the IP address of the Internet refrigerator 10.

Thus, when a remote user wants to access the Internet refrigerator 10 through the Internet 1, the user inputs the domain of the Internet refrigerator 10 into the user terminal 5. Then, the inputted domain is transmitted to the DDNS 3, and the DDNS 3 ascertains the IP of the Internet refrigerator 10 depending upon the domain inputted by a user.

Where the user inquires about the IP address of the Internet refrigerator 10, the DDNS 3 first ascertains whether the Internet refrigerator 10 is accessing the Internet, and, where the Internet refrigerator 10 is accessing the Internet 1, it supplies the user with the current IP address information. The user is allowed to access the web page of the Internet refrigerator 10 through the Internet 1, according to the IP address information of the Internet refrigerator 10 supplied by the DDNS 3.

If it is determined by the DDNS 3 that the Internet refrigerator 10 to which the user desires to make an access is not accessing the Internet 1, the DDNS 3 displays a page indicating to the user that the Internet refrigerator 10 is released from accessing the Internet. Here, the web page indicating the release of Internet access may be displayed on the user terminal 5 by use of the access-releasing page provided in itself by the DDNS 3, or the user may be allowed to access the access-releasing page since the user is supplied with the IP address of the access-releasing page provided by the manufacturer of the Internet refrigerator 10.

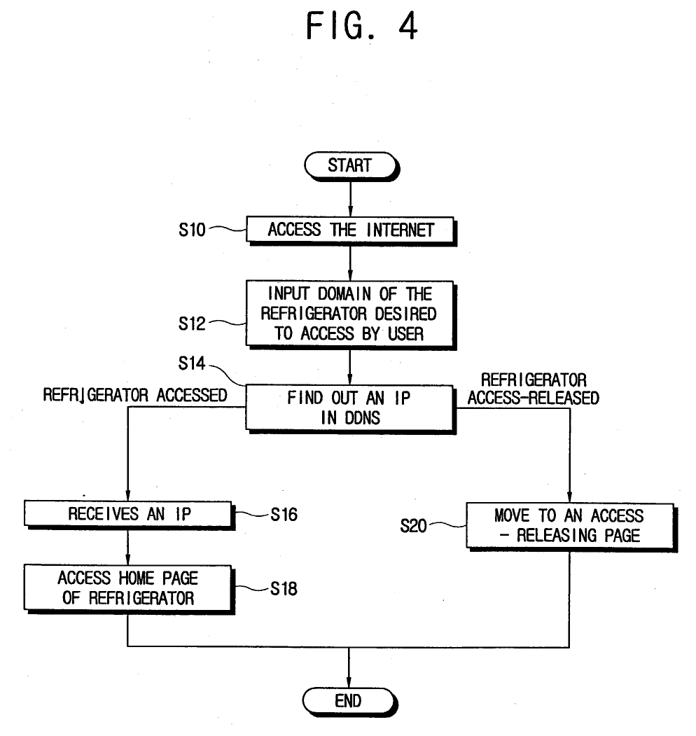

With this configuration, a process of the user accessing the Internet refrigerator 10 using the remote control system employing the present system according to the present invention is illustrated in the flow chart of FIG. 4.

The user in a remote place accesses the Internet 1 by use of the terminal 5 (S10), and inputs the domain of the Internet refrigerator 10 to which he/she desires to make an access (S12). If the inputted domain is transmitted to the DDNS3, the DDNS3 finds out the IP matching the inputted domain (S14). The operation of finding out the IP address may be performed by allowing the user to insert the domain of his/her own Internet refrigerator 10 into the web browser. In other words, if the user directly inputs the domain of the Internet refrigerator 10 to which he/she desires to access, on an address window of the web browser, the inputted domain is transmitted to the DDNS 3 and the DDNS 3 determines the IP address appropriate for the inputted domain.

Here, where the Internet refrigerator 10 is accessing the Internet, the user can be supplied with the current IP address of the Internet refrigerator 10 from the DDNS 3 (S16), and can access the home page of the Internet refrigerator 10 through the supplied IP address (S18). The user may recognize that he/she has accessed the home page of the Internet refrigerator 10 only by inserting the domain of the Internet refrigerator 10 to which he/she desires to access, onto the web browser.

Where the Internet refrigerator 10 is not accessing the Internet 1, the DDNS 3 allows the user terminal 5 to be accessed to the access-releasing page (S20). Accordingly, the user can recognize that the access of the Internet refrigerator 10 to the Internet has been released.

As described above, the system according to the present invention enables the user, who is desirous of accessing an Internet refrigerator through the Internet at a distant place, to receive the IP address information from the server and access the Internet refrigerator, by allowing the Internet refrigerator assigned a variable IP address to supply the currently assigned IP address to the server.

As described above, there is provided a remote control system of an Internet accessible refrigerator and a method of remote control of the refrigerator, wherein a user in a remote place can access the Internet refrigerator by a remote control through a terminal in the case of the refrigerator assigned a variable IP address.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although an embodiment of the present invention has been shown and described, it will be appreciated by those skilled in the art that changes may be made in these embodiments without departing from the principles and spirit of the invention, the scope of which is defined in the appended claims and their equivalents.

What is claimed is:

1. A method of remotely controlling an Internet refrigerator having an own proper ID, comprising:
transmitting a variable internet protocol (IP) address information assigned to the Internet refrigerator where the Internet refrigerator accesses the Internet, and the proper ID, to a server from the Internet refrigerator;
storing in the server the proper ID and the IP address information pertaining to the Internet refrigerator;
supplying the IP address information of the Internet refrigerator as appropriate, according to the proper ID address inputted by a user who has access to the server through the Internet, to a user terminal; and
allowing the user terminal to access the Internet refrigerator, based on the IP information received from the server.

2. The method according to claim 1, wherein the proper ID comprises a domain name assigned to the Internet refrigerator.

3. The method according to claim 1, wherein the server comprises a dynamic domain name server (DDNS).

4. The method according to claim 1, wherein the supplying the IP information to the user terminal comprises:
determining whether the Internet refrigerator is accessing the Internet; and
supplying the IP address information to the user terminal where the Internet refrigerator is in access.

5. The method according to claim 4, further comprising:
displaying a web page indicating that the access of the Internet refrigerator is released on the user terminal, where the Internet refrigerator is released from the access.

6. A system for remotely controlling an Internet refrigerator having an Internet interface for an access to the Internet, a proper ID storing unit storing therein a proper ID of the refrigerator, a web page storing unit storing therein a web page, and a web controlling unit displaying the web page on a user terminal accessed through the Internet, comprising:
an IP address transmitting unit provided in the Internet refrigerator, transmitting an IP address information variably assigned at a time of accessing the Internet through the Internet interface and the proper ID; and
a server including a domain storing unit storing therein a proper domain assigned to the Internet refrigerator, a domain controlling module matching the IP address information received from the IP address transmitting unit with the proper domain, and a server controlling unit supplying the user terminal with a current IP address information appropriate for the proper domain of the Internet refrigerator, according to the proper domain inputted using the user terminal.

7. The system according to claim 6, wherein the proper ID comprises a domain name assigned to the Internet refrigerator.

8. The system according to claim 6, wherein the server comprises a dynamic domain name server (DDNS).

9. The system according to claim 6, wherein the server controlling unit determines a status that the Internet refrigerator is accessing the Internet, according to the proper domain inputted through the user terminal, and supplies the current IP address information that is appropriate for the proper domain to the user terminal where the Internet refrigerator is accessing the Internet.

10. The system according to claim 9, wherein the server controlling unit indicates a web page informing an access-release of the Internet refrigerator on the user terminal, in response to the determination that the Internet refrigerator is released from accessing the Internet.

11. A system for remotely controlling a refrigerator that is connected to the Internet, comprising:
a refrigerator that is connected to the Internet;
a user terminal to remotely access and control the refrigerator via the Internet; and
a dynamic domain name server to manage a dynamic internet protocol (IP) address of the refrigerator and to provide the dynamic IP address to the user terminal.

12. The system of claim 11, wherein the user terminal is a computer, a personal digital assistant (PDA), or a mobile phone.

13. The system of claim 11, wherein the refrigerator comprises:
an Internet interface to enable the refrigerator to access the Internet;
a refrigerator control module to perform general functions of the refrigerator;
a domain storing unit to store a proper domain assigned to the refrigerator;
a web page storing unit to store World Wide Web (web) pages;
a dynamic domain name server client module to transfer the dynamic IP address to the dynamic domain name server; and
a web control unit to control the Internet interface, the refrigerator control module, the domain storing unit, the web page storing unit, and the dynamic domain name server client module.

14. The system of claim 13, wherein the Internet interface comprises means for wireless connection to the Internet.

15. The system of claim 13, wherein the Internet interface comprises means for wired connection to the Internet.

16. The system of claim 13, wherein the web page storing unit stores web pages that are inherently in the user terminal.

17. The system of claim 13, wherein the refrigerator control module transmits data regarding the setup and operation of the refrigerator to the user terminal via the Internet to enable a user to control the refrigerator.

18. The system of claim 17, wherein the web control unit causes the user terminal to display the data stored in the web page storing unit and the data transmitted from the refrigerator control module.

19. The system of claim 13, further comprising:
a home network control module, which is connected to a local network, to control a plurality of other appliances connected to the local network.

20. The system of claim 11, wherein the user terminal transmits a domain, which includes the refrigerator, to the dynamic domain name server.

21. A method of remotely controlling a refrigerator that is connected to the Internet, comprising:
receiving a domain of a refrigerator from a user terminal via the Internet;
determining whether the refrigerator is connected to the Internet; and
transmitting a dynamic IP address of the refrigerator to the user terminal via the Internet if the refrigerator is connected to the Internet.

22. A machine-readable medium that provides instructions, which, when executed by a machine, cause the machine to perform operations for remotely controlling a refrigerator that is connected to the Internet, comprising:
receiving a domain of a refrigerator from a user terminal via the Internet;
determining whether the refrigerator is connected to the Internet; and
transmitting a dynamic IP address of the refrigerator to the user terminal via the Internet if the refrigerator is connected to the Internet.
